(19) United States
(12) Patent Application Publication
(10) Pub. No.: US 2026/0158700 A1
(43) Pub. Date: Jun. 11, 2026

(54) HANDHELD POWER TOOL AND CHAINSAW

(71) Applicant: Nanjing Chervon Industry Co., Ltd., Nanjing (CN)

(72) Inventors: Zhe Wu, Nanjing (CN); Jifeng Feng, Nanjing (CN); Xiangmin Shen, Nanjing (CN); Zhaodi Ou, Nanjing (CN); Yang Li, Nanjing (CN); Haoyu Wang, Nanjing (CN)

(21) Appl. No.: 19/073,886

(22) Filed: Mar. 7, 2025

(30) Foreign Application Priority Data
Dec. 11, 2024 (CN) 202411819149.2
Dec. 11, 2024 (CN) 202411827954.X
Dec. 11, 2024 (CN) 202411828098.X
Dec. 11, 2024 (CN) 202423061653.9

(51) Int. Cl. B27G 19/00; B27B 17/08

(52) U.S. Cl. CPC B27G 19/003; B27B 17/08

(57) ABSTRACT

Provided are a handheld power tool and a chainsaw. After the battery pack is mounted on the handheld power tool, in the case where the handheld power tool does not satisfy the balance requirement, the electric motor does not start.

### RELATED APPLICATION INFORMATION

This application claims the benefit under 35 U.S.C. § 119(a) of Chinese Patent Application No. 202411828098.X, filed on Dec. 11, 2024, Chinese Patent Application No. 202423061653.9, filed on Dec. 11, 2024, Chinese Patent Application No. 202411827954.X, filed on Dec. 11, 2024, and Chinese Patent Application No. 202411819149.2, filed on Dec. 11, 2024, which applications are incorporated herein by reference in their entireties.

### TECHNICAL FIELD

The present application relates to a power tool and, in particular, to a handheld power tool and a chainsaw.

### BACKGROUND

A handheld power tool, such as a chainsaw, a string trimmer, or a hedge trimmer, is a type of garden power tool and is widely used in homes, gardens, and other fields.

In the handheld power tool, the battery pack is usually used to supply power to the electric motor to drive the actuator of the handheld power tool to work. The battery pack is replaceable. If the battery pack for replacing the previous battery pack is heavy or large in dimension, a problem that the battery pack does not match the tool body of the handheld power tool exists, causing the balance of the entire handheld power tool to worsen, resulting in certain insecurity during operation or reducing the working effect.

### SUMMARY

In this application, a handheld power tool is provided. The handheld power tool includes a tool body, a battery mounting portion, an electric motor, and a control circuit. The battery mounting portion is disposed on the tool body and used for mounting a battery pack. The electric motor is disposed in the tool body. The control circuit is configured to control the startup or rotational state of the electric motor. The control circuit includes a parameter detection module and a controller. The parameter detection module acquires battery communication data at least when the battery pack is mounted onto the battery mounting portion. The controller determines, according to the battery communication data, a center of gravity or a center of gravity offset of the tool body on which the battery pack is mounted, wherein in a case where a change in the center of gravity relative to a preset center of gravity is greater than a change threshold, or in a case where the center of gravity offset is greater than an offset threshold, the electric motor does not start.

In a first aspect, a handheld power tool is provided. The handheld power tool includes a tool body, a battery mounting portion, an electric motor, and a control circuit. The battery mounting portion is disposed on the tool body and used for mounting a battery pack. The electric motor is disposed in the tool body. The control circuit is configured to control the startup or rotational state of the electric motor. The control circuit includes a parameter detection module and a controller. The parameter detection module acquires battery communication data at least when the battery pack is mounted onto the battery mounting portion. The controller determines, according to the battery communication data, the center of gravity of the tool body on which the battery pack is mounted. In the case where the change in the center of gravity relative to the preset center of gravity is greater than a change threshold, the electric motor does not start.

In some examples, the controller is configured to acquire the change by looking up a table chart according to the battery communication data.

In some examples, the controller is configured to issue alarm information in the case where the change is greater than the change threshold.

In some examples, the controller is configured to disconnect the power supply path between the battery pack and the electric motor in the case where the change is greater than the change threshold.

In some examples, the controller is configured to send a no-start control signal in the case where the change is greater than the change threshold, thereby controlling the electric motor not to start.

In some examples, the controller is configured not to respond to a start signal in the case where the change is greater than the change threshold so that the electric motor does not start.

In some examples, the battery communication data includes at least one of the battery pack model, the battery pack weight, the battery pack capacity, and the battery pack volume.

The present application has the beneficial effects below.

In the handheld power tool provided in the present application, when the battery pack is mounted on the battery mounting portion, the parameter detection module of the control circuit is used for acquiring the battery communication data, and according to the battery communication data, the controller determines the center of gravity of the tool body on which the battery pack is mounted. In the case where the change in the center of gravity relative to the preset center of gravity is greater than the change threshold, the handheld power tool does not satisfy the balance requirement, and the electric motor does not start, thereby avoiding safety risks or an impact on the working effect during operation.

In a second aspect, a handheld power tool is provided. The handheld power tool includes a tool body, a battery mounting portion, an electric motor, and a control circuit. The battery mounting portion is disposed at the rear end of the tool body and used for mounting a battery pack. The electric motor is disposed in the tool body. The control circuit is configured to control the startup or rotational state of the electric motor. The control circuit includes a parameter detection module and a controller. The parameter detection module acquires battery communication data at least when the battery pack is mounted onto the battery mounting portion. The controller identifies the battery pack according to the battery communication data. In the case where the type of the battery pack does not satisfy the startup requirement, the electric motor does not start.

In some examples, the controller is configured to acquire the type of the battery pack by looking up a table chart according to the battery communication data.

In some examples, the controller is configured to issue alarm information in the case where the type of the battery pack does not satisfy the startup requirement.

In some examples, the controller is configured to disconnect the power supply path between the battery pack and the electric motor in the case where the type of the battery pack does not satisfy the startup requirement.

In some examples, the controller is configured to send a no-start control signal in the case where the type of the battery pack does not satisfy the startup requirement, thereby controlling the electric motor not to start.

In some examples, the controller is configured not to respond to a start signal in the case where the type of the battery pack does not satisfy the startup requirement so that the electric motor does not start.

The present application has the beneficial effects below.

In the handheld power tool provided in the present application, when the battery pack is mounted on the battery mounting portion, the parameter detection module of the control circuit is used for acquiring the battery communication data, and the controller determines the type of the battery pack according to the battery communication data. In the case where the type of the battery pack does not satisfy the startup requirement, the handheld power tool does not satisfy the balance requirement, and the electric motor does not start, thereby avoiding safety risks or an impact on the working effect during operation.

In a third aspect, a chainsaw is provided. The chainsaw includes a tool body, a battery mounting portion, an electric motor, and a control circuit. The battery mounting portion is disposed on the tool body and used for mounting a battery pack. The electric motor is disposed in the tool body. The control circuit is configured to control the startup or rotational state of the electric motor. The control circuit includes a parameter detection module and a controller. The parameter detection module acquires battery communication data at least when the battery pack is mounted onto the battery mounting portion. The controller determines, according to the battery communication data, the center of gravity offset of the tool body on which the battery pack is mounted. In the case where the center of gravity offset is greater than an offset threshold, the electric motor does not start.

In some examples, the controller is configured to acquire the center of gravity offset by looking up a table chart according to the battery communication data.

In some examples, the controller is configured to issue alarm information in the case where the center of gravity offset is greater than the offset threshold.

In some examples, the controller is configured to disconnect the power supply path between the battery pack and the electric motor in the case where the center of gravity offset is greater than the offset threshold.

In some examples, the controller is configured to send a no-start control signal in the case where the center of gravity offset is greater than the offset threshold, thereby controlling the electric motor not to start.

In some examples, the controller is configured not to respond to a start signal in the case where the center of gravity offset is greater than the offset threshold so that the electric motor does not start.

In some examples, the battery communication data includes at least one of the battery pack model, the battery pack weight, the battery pack capacity, and the battery pack volume.

The present application has the beneficial effects below.

In the chainsaw provided in the present application, when the battery pack is mounted onto the battery mounting portion, the center of gravity offset after the battery pack is mounted on the tool body is determined according to the battery communication data. In the case where the center of gravity offset is greater than the offset threshold, the chainsaw is unbalanced, and the electric motor does not start, thereby avoiding the following: the chainsaw tilts, causing safety risks during operation and a poor working effect.

In a fourth aspect, a handheld power tool is provided. The handheld power tool includes a tool body, a power supply mounting portion, an electric motor, and a control circuit.

The power supply mounting portion is disposed on the tool body and used for mounting a power conversion device.

The electric motor is disposed in the tool body.

The control circuit is configured to control the startup or rotational state of the electric motor.

The control circuit includes a parameter detection module and a controller.

The parameter detection module acquires at least the power supply communication data from the power conversion device.

In the case where the controller determines that the power supply connected to the power conversion device is a portable power supply according to the power supply communication data, the controller can control the electric motor to start in response to the startup information.

In some examples, the controller is configured to, when determining that the power supply connected to the power conversion device is the portable power supply, establish the power supply path between the battery pack and the electric motor.

In some examples, the controller is configured to, when determining that the power supply connected to the power conversion device is the portable power supply, send a start control signal to control the electric motor to start.

In some examples, the controller is configured to, when determining that the power supply connected to the power conversion device is the portable power supply, respond to a start signal to start the electric motor.

The present application has the beneficial effects below.

In the handheld power tool provided in the present application, when the battery pack is mounted onto the battery mounting portion, the parameter detection module of the control circuit is used for acquiring the battery communication data. In the case where it is determined that the power supply connected to the power conversion device is the portable power supply, the balance of the handheld power tool does not change. Therefore, the electric motor is started without safety risks during operation, and the working effect is not affected.

### BRIEF DESCRIPTION OF THE DRAWINGS

FIG. 1 is a top view of a chainsaw according to an example of the present application.

FIG. 2 is a bottom view of a chainsaw according to an example of the present application.

FIG. 3 is another view illustrating the structure of a chainsaw according to an example of the present application.

FIG. 4 is a first side view of a chainsaw according to an example of the present application.

FIG. 5 is a view illustrating the structure of a suspended chainsaw according to an example of the present application from a first perspective.

FIG. 6 is a view illustrating the structure of a suspended chainsaw according to an example of the present application from a second perspective.

FIG. 7 is a second side view of a chainsaw according to an example of the present application.

FIG. 8A is an axial schematic view illustrating the structures of a chain cover, a tensioning device, and an adjustment knob according to an example of the present application.

FIG. 8B is a sectional view illustrating the structures of a chain cover, a tensioning device, and an adjustment knob according to an example of the present application.

FIG. 9 is a view illustrating the structure of a sawdust guard rib according to an example of the present application.

FIG. 10 is a view illustrating the structure of a shielding rib according to an example of the present application from a first perspective.

FIG. 11 is a view illustrating the structure of a shielding rib according to an example of the present application from a second perspective.

FIG. 12 is a view illustrating the structure of a chainsaw placed on a plane when a battery pack is not mounted according to an example of the present application.

FIG. 13 is a structural view illustrating the installation of an oil pump according to an example of the present application.

FIG. 14 is a structural view illustrating the installation of an oil tank according to an example of the present application.

### DETAILED DESCRIPTION

Before any example of the present application is explained in detail, it is to be understood that the present application is not limited to its application to the structural details and the arrangement of components set forth in the following description or illustrated in the preceding drawings.

In the present application, the terms “comprising”, “including”, “having”, or any other variation thereof are intended to cover an inclusive inclusion such that a process, method, article, or device including a series of elements includes not only those series of elements, but also other elements not expressly listed, or elements inherent in the process, method, article, or device. Without further limitations, an element defined by the phrase “comprising a . . . ” does not exclude the presence of additional identical elements in the process, method, article, or device including this element.

In the present application, the term “and/or” is used for describing the association relationship between associated objects, which means that three types of relationships may exist. For example, A and/or B may indicate that A exists alone, A and B exist simultaneously, and B exists alone. In addition, the character “/” in the present application generally indicates the “and/or” relationship between the associated objects before and after the character “/”.

In the present application, the terms “connection”, “combination”, “coupling”, and “mounting” may be the direct connection, combination, coupling, or mounting and may also be the indirect connection, combination, coupling, or mounting. For example, direct connection means that two members or assemblies are connected together without intermediate members, and indirect connection means that two members or assemblies are separately connected to at least one intermediate member and the two members or assemblies are connected to each other by the at least one intermediate member. In addition, “connection” and “coupling” are not limited to physical or mechanical connections or couplings and may include electrical connections or couplings.

In the present application, it is to be understood by those of ordinary skill in the art that a relative term (such as “about”, “approximately”, or “basically”) used in conjunction with a quantity or a condition includes a stated value and has a meaning dictated by the context. For example, the relative term includes at least a degree of error associated with the measurement of a particular value, a tolerance caused by manufacturing, assembly, and usage and associated with the particular value, and the like. Such a relative term should also be considered as disclosing the range defined by the absolute values of the two endpoints. The relative term may refer to that an indicated value is added or reduced by a certain percentage (such as 1%, 5%, 10%, or more). A value not modified by the relative term should also be disclosed as a particular value with a tolerance. In addition, when expressing a relative angular position relationship (for example, basically parallel or basically perpendicular), “basically” may refer to that a certain degree (such as 1 degree, 5 degrees, 10 degrees, or more) is added to or subtracted from the indicated angle.

In the present application, those of ordinary skill in the art will understand that a function implemented by an assembly may be implemented by one assembly, multiple assemblies, one part, or multiple parts. Similarly, a function implemented by a part may be implemented by one part, one assembly, or a combination of multiple parts.

In the present application, the terms “up”, “down”, “left”, “right”, “front”, “rear”, and other orientation words are described based on the orientation or positional relationship shown in the drawings and should not be understood as limitations to the examples of the present application. In addition, in this context, it also needs to be understood that when it is mentioned that an element is connected “above” or “below” another element, the element can not only be directly connected “above” or “below” the other element but can also be indirectly connected “above” or “below” the other element through an intermediate element. Further, it is to be understood that orientation words such as the upper side, the lower side, the left side, the right side, the front side, and the rear side not only represent primary orientations but can also be understood as lateral orientations. For example, the lower side may include directly below, bottom left, bottom right, front bottom, and rear bottom.

In the present application, the terms “controller”, “processor”, “central processing unit”, “central processing unit (CPU)”, and “microcontroller unit (MCU)” are interchangeable. When a unit such as the “controller”, the “processor”, the “central processing unit”, the “CPU”, or the “MCU” is configured to implement specific functions, these functions may be implemented by a single preceding unit or multiple preceding units unless otherwise indicated.

In the present application, the term “device”, “module”, or “unit” is used for implementing a specific function in the form of hardware or software.

In the present application, the terms “computing”, “judging”, “controlling”, “determining”, “identifying”, and the like refer to the operations and processes of a computer system or similar electronic computing device (for example, the controller, the processor, or the like).

This example provides a handheld power tool. The handheld power tool may be a chainsaw, a string trimmer, a hedge trimmer, or the like.

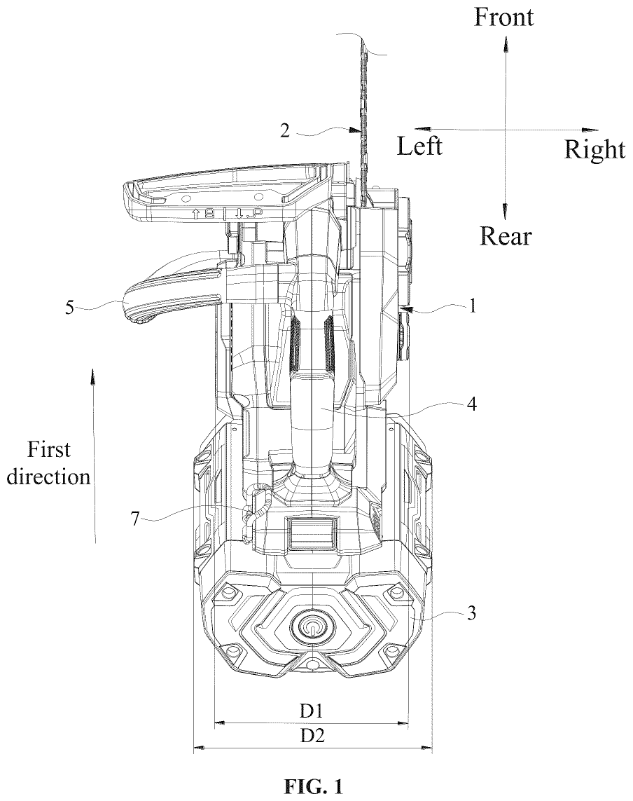

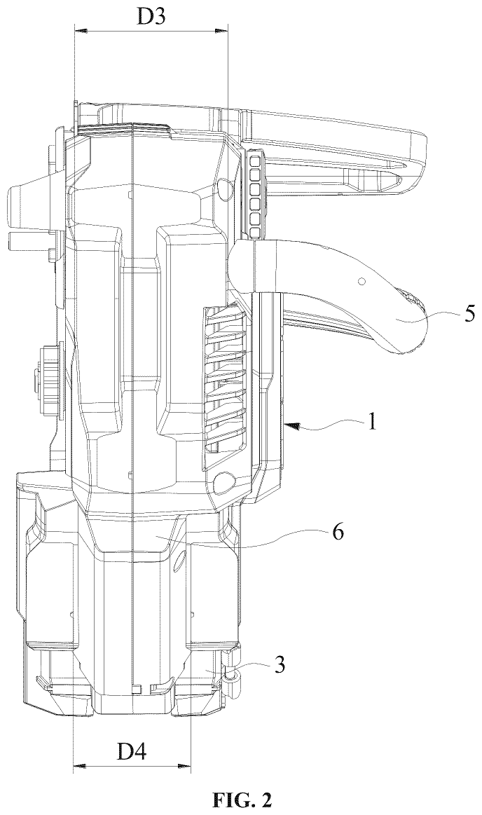

As shown in FIGS. 1 and 2, the handheld power tool includes a tool body 1, a battery mounting portion 6, an electric motor, and a control circuit. The battery mounting portion 6 is disposed on the tool body 1, and a battery pack 3 is mounted on the battery mounting portion 6. The electric motor is disposed in the tool body 1. The handheld power tool further includes an actuator 2. The control circuit is configured to control the startup or rotational state of the electric motor so that the electric motor drives the actuator 2 to operate. Actuators in different types of handheld power tools have different structures and implement different functions.

Typically, a power tool can be powered by a variety of battery packs with different capacities. The entire tool on which different battery packs are mounted has different centers of gravity. For some handheld power tools, especially handheld power tools with the battery pack mounted at the rear end, if the center of gravity of the whole machine shifts too far backward after the battery pack is mounted, the balance of operation is affected, possibly causing some safety problems, such as the problem of a chainsaw or mower tilting.

To solve this problem, the control circuit includes a parameter detection module and a controller, and the parameter detection module acquires the battery communication data at least when the battery pack 3 is mounted onto the battery mounting portion 6. After the handheld power tool is powered on, the parameter detection module communicates with the battery pack 3, acquires relevant information about the battery pack 3, and analyzes the relevant information to acquire the battery communication data. According to the battery communication data, the controller determines the center of gravity of the tool body 1 after the battery pack 3 is mounted. In this example, the battery communication data includes at least one of the battery pack model, the battery pack weight, the battery pack capacity, and the battery pack volume. That is to say, the battery communication data represents the attribute information of the battery pack 3. When the different battery packs 3 are mounted on the tool body 1, the whole machine has different centers of gravity. In an example, the centers of gravity of the power tool after different battery packs 3 are mounted onto the same power tool may be recorded and stored. For example, a chainsaw can be compatible with 1P, 2P, or 3P battery packs in a battery platform. When the whole machine is powered by the 1P battery pack, the center of gravity of the whole machine is closer to the guide plate side or closer to the front end. When the 3P battery pack is used, the center of gravity of the whole machine may be closer to the rear end or closer to the battery pack. In actual applications, the center of gravity test can be performed on all battery packs with which the power tool is compatible. For example, when a battery pack with a capacity of 1 is mounted on the power tool, the center of gravity of the whole machine is marked as 1 in the coordinate system; when a battery pack with a capacity of 2 is mounted, the center of gravity of the whole machine is marked as 2 in the coordinate system; and so on. After all the tests are completed, the capacities of the battery packs and the centers of gravity in the coordinate system may be stored correspondingly. It is to be understood that other parameters of the battery pack may replace the capacities and be stored corresponding to the centers of gravity in the coordinate system. Further, the center of gravity of the power tool on which the battery pack 3 is mounted can be determined according to any attribute parameter carried by the battery communication data.

It is to be understood that the power tool may further include a storage device that can store a data list corresponding to the battery communication data and the center of gravity of the whole machine on which the battery pack 3 is mounted. In this example, the storage device may further store a preset center of gravity, which may be understood as a critical value. It is to be understood that in the case where the center of gravity of the power tool on which the battery pack 3 is mounted is the preset center of gravity, no safety problems due to failure to satisfy the balance requirement occur. If the center of gravity after the battery pack 3 is mounted has a significant change relative to the preset center of gravity, a safety problem may occur. Otherwise, if the change is not significant, the safe operation of the tool can be ensured. That is to say, if the change in the center of gravity of the tool on which the battery pack 3 is mounted relative to the preset center of gravity is greater than a change threshold, the handheld power tool may not satisfy the balance requirement.

In this example, if the change is greater than the change threshold, the electric motor may be controlled not to start, thereby avoiding safety risks or an impact on the working effect during operation. In an example, the battery communication data, the corresponding center of gravity after the battery pack 3 is mounted, and the change in the center of gravity relative to the preset center of gravity may be correspondingly stored in the storage device.

The controller is configured to acquire the change by looking up a table chart according to the battery communication data and then according to the acquired change, determine whether to start the electric motor.

In an example, the controller is configured to issue alarm information in the case where the change is greater than the change threshold, thereby reminding the user that the mounted battery pack 3 does not match the tool body 1. The alarm information may be an audible alarm, a visual alarm, or an audible and visual alarm.

In an example, the controller is configured to disconnect the power supply path between the battery pack 3 and the electric motor in the case where the change is greater than the change threshold so that no power is supplied to the electric motor. Even if a signal for starting the handheld power tool is sent to the controller, the electric motor does not start and the handheld power tool does not work, thereby ensuring the usage safety of the user.

In an example, the controller is configured to send a no-start control signal in the case where the change is greater than the change threshold, thereby controlling the electric motor not to start. Even if a signal for starting the handheld power tool is sent to the controller, the electric motor does not start and the handheld power tool does not work, thereby ensuring the usage safety of the user.

In an example, the controller is configured not to respond to a start signal in the case where the change is greater than the change threshold so that the electric motor does not start. Even if a signal for starting the handheld power tool is sent to the controller, the electric motor does not start, thereby ensuring the usage safety of the user.

In the preceding example, the battery communication data may include the capacity, weight, and other attribute parameters of the battery pack 3. One or more of these parameters can represent the type of the battery pack 3. It is to be understood that after the type of the battery pack 3 is determined, the change in the center of gravity of the whole machine caused by the battery pack 3 mounted on the power tool can be basically determined. Therefore, it is to be simply understood that after the type of the battery pack 3 is known, whether the battery pack 3 is suitable for installation on the power tool and whether the safety problems caused by imbalance occur can be determined.

In this example, the controller is configured to acquire the type of the battery pack 3 by looking up a table chart according to the battery communication data and not to start the electric motor in the case where the type of the battery pack 3 does not satisfy the startup requirement. The power tool with the battery pack 3 mounted at the rear end of the tool is used as an example. The case where the type of the battery pack 3 does not satisfy the startup requirement may be understood as follows: after this type of battery pack 3 is mounted onto the power tool, the center of gravity of the power tool shifts backward significantly, causing the power tool to be unbalanced and bringing safety problems such as tilting. For example, if the type of the battery pack 3 is A and the corresponding change in the center of gravity relative to the preset position after the battery pack 3 is mounted is greater than the change threshold, then the battery pack 3 of type A does not satisfy the startup requirement of the power tool.

In an example, the controller is configured to issue alarm information in the case where the type of the battery pack 3 does not satisfy the startup requirement, thereby reminding the user that the mounted battery pack 3 does not match the tool body 1. The alarm information may be an audible alarm, a visual alarm, or an audible and visual alarm.

In an example, the controller is configured to disconnect the power supply path between the battery pack 3 and the electric motor in the case where the type of the battery pack 3 does not satisfy the startup requirement so that no power is supplied to the electric motor. Even if a signal for starting the handheld power tool is sent to the controller, the electric motor does not start and the handheld power tool does not work, thereby ensuring the usage safety of the user.

In an example, the controller is configured to send a no-start control signal in the case where the type of the battery pack 3 does not satisfy the startup requirement, thereby controlling the electric motor not to start. Even if a signal for starting the handheld power tool is sent to the controller, the electric motor does not start and the handheld power tool does not work, thereby ensuring the usage safety of the user.

In an example, the controller is configured not to respond to a start signal in the case where the type of the battery pack 3 does not satisfy the startup requirement so that the electric motor does not start. Even if a signal for starting the handheld power tool is sent to the controller, the electric motor does not start, thereby ensuring the usage safety of the user.

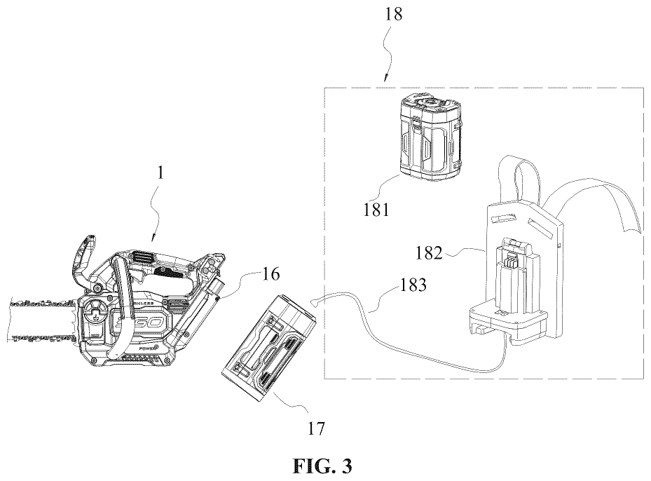

In an example, as shown in FIGS. 1 and 3, the handheld power tool is a chainsaw, and the chainsaw includes the tool body 1, the battery mounting portion 6, the electric motor, and the control circuit. The battery mounting portion 6 is disposed on the tool body 1, and the battery pack 3 is mounted on the battery mounting portion 6. The electric motor is disposed in the tool body 1, and the control circuit is configured to control the startup or rotational state of the electric motor. The control circuit includes a parameter detection module and a controller, and the parameter detection module acquires the battery communication data at least when the battery pack 3 is mounted onto the battery mounting portion 6. According to the battery communication data, the controller determines the center of gravity offset after the battery pack 3 is mounted on the tool body 1. In the case where the center of gravity offset is greater than an offset threshold, the chainsaw is unbalanced, and the electric motor does not start, thereby avoiding the following: the chainsaw tilts, causing safety risks during operation and a poor working effect. The center of gravity offset may be understood as the difference between the two centers of gravity before and after the battery pack 3 is mounted on the tool and may include the distance between the two centers of gravity and the relative positional relationship. In this example, the center of gravity offset may be stored in the storage device.

In an example, the controller is configured to acquire the center of gravity offset by looking up a table chart according to the battery communication data, determine whether the chainsaw is unbalanced according to the acquired center of gravity offset, and then determine whether to start the electric motor.

Generally, the center of gravity of the whole machine after the battery pack 3 is mounted on the chainsaw is closer to the rear end of the whole machine than the center of gravity of the whole machine before the battery pack 3 is mounted on the chainsaw. When the backward displacement of the center of gravity reaches a certain amount, the center of gravity offset is greater than the offset threshold. The controller is configured to issue alarm information in the case where the center of gravity offset is greater than the offset threshold, thereby reminding the user that the mounted battery pack 3 does not match the tool body 1. The alarm information may be an audible alarm, a visual alarm, or an audible and visual alarm.

In an example, the controller is configured to disconnect the power supply path between the battery pack 3 and the electric motor in the case where the center of gravity offset is greater than the offset threshold so that no power is supplied to the electric motor. Even if a signal for starting the chainsaw is sent to the controller, the electric motor does not start and the chainsaw does not work, thereby ensuring the usage safety of the user.

In an example, the controller is configured to send a no-start control signal in the case where the center of gravity offset is greater than the offset threshold, thereby controlling the electric motor not to start. Even if a signal for starting the chainsaw is sent to the controller, the electric motor does not start and the chainsaw does not work, thereby ensuring the usage safety of the user.

In an example, the controller is configured not to respond to a start signal in the case where the center of gravity offset is greater than the offset threshold so that the electric motor does not start. Even if a signal for starting the chainsaw is sent to the controller, the electric motor does not start, thereby ensuring the usage safety of the user.

In some cases, a backpack battery pack or a portable power supply such as a portable battery pack may be used for supplying power to the power tool. If the backpack battery pack is used for power supply, the corresponding battery pack type or parameters such as the change in center of gravity or the center of gravity offset are searched according to the battery communication data to determine whether the battery pack causes balance or safety problems with the tool, and if the battery pack causes balance or safety problems with the tool, the battery pack is no longer used. Therefore, before whether the installation of the battery pack causes the imbalance of the entire power tool and poses a safety hazard is determined, it is necessary to determine whether the battery pack with which the power tool is compatible is a portable battery pack or a backpack battery pack.

As shown in FIG. 3, the handheld power tool further includes a power supply mounting portion 16. The power supply mounting portion 16 is disposed on the tool body 1. The power supply mounting portion 16 is used for mounting a power conversion device 17. The power conversion device 17 may be understood as an adapter but does not have components such as cells that can store a large amount of electrical energy.

As shown in FIG. 3, the power tool is provided as a chainsaw, and the power conversion device 17 is mounted on the power supply mounting portion 16 of the chainsaw. A portable power supply 18 can be electrically connected to the power conversion device 17, and the power conversion device 17 may convert the electrical energy of the portable power supply 18, thereby supplying power to the power tool. In this example, the portable power supply 18 includes a first battery pack 181, a backpack assembly 182, and a power cord 183. After mounted on the backpack assembly 182, the first battery pack 181 can be carried on the operator's back, thereby avoiding the inconvenience or safety hazard caused by the excessive weight of the first battery pack 181 on the operation of the tool. It is to be understood that the weight and volume of the power conversion device 17 are basically fixed. After mounted on the power tool, the power conversion device 17 does not cause a large shift in the center of gravity of the entire tool and does not cause the tool such as the chainsaw to tilt.

In this example, the parameter detection module acquires at least the power supply communication data from the power conversion device 17. In the case where the controller determines that the power supply connected to the power conversion device 17 is the portable power supply 18 according to the power supply communication data, the balance of the handheld power tool does not change, and the electric motor can be controlled to start in response to the startup information, no safety risk exists during operation, and the working effect is not affected.

In an example, the controller is configured to, when determining that the power supply connected to the power conversion device 17 is the portable power supply 18, establish the power supply path between the portable power supply 18 and the electric motor, thereby supplying power to the electric motor.

In an example, the controller is configured to, when determining that the power supply connected to the power conversion device 17 is the portable power supply 18, send a start control signal to control the electric motor to start.

In an example, the controller is configured to, when determining that the power supply connected to the power conversion device 17 is the portable power supply 18, respond to a start signal to start the electric motor.

With continued reference to FIG. 1, the handheld power tool is the chainsaw, and the chainsaw includes the tool body 1, the actuator 2, the electric motor, and the battery pack 3. The actuator 2 is coupled to the tool body 1 along a first direction. The actuator 2 includes a chain guide plate 21 and a chain 22 mounted on the chain guide plate 21. The electric motor is disposed in the tool body 1 and can drive the actuator 2. The battery pack 3 is mounted on the tool body 1, and the battery pack 3 is used for supplying electrical energy to the electric motor.

The ratio of the maximum width D1 of the projection of the tool body 1 on the horizontal plane to the width D2 of the projection of the battery pack 3 on the horizontal plane is greater than or equal to 0.5 and less than or equal to 1. For example, the ratio may be 0.6, 0.7, 0.8, 0.9, or the like. The width of the battery pack 3 can at least ensure that after the battery pack 3 is mounted onto the chainsaw, the balance angle of the actuator 2 does not increase, thereby avoiding the problem of the tool body 1 tilting at the balance position of the chainsaw. In addition, the width of the tool body 1 is less than the width of the battery pack 3, and the width of the battery pack 3 is the maximum width of the chainsaw. In this manner, in the case where the balance of the whole machine is ensured, the width of the tool body 1 does not increase, thereby not increasing the width of the chainsaw.

A first handle 4 extending basically along the first direction is formed on the upper end surface of the tool body 1, and a second handle 5 is formed on the left side surface or right side surface of the tool body 1. The first handle 4 and the second handle 5 can be held by the user. The battery mounting portion 6 for mounting the battery pack 3 is formed on the rear end surface of the tool body 1. The battery pack 3 is disposed at the rear end of the tool body 1. If the balance performance of the tool body 1 worsens after the battery pack 3 is mounted, problems such as the chainsaw tilting exist, affecting the cutting work. Therefore, the battery pack 3 matching the tool body 1 is required.

In conjunction with FIGS. 1 and 2, the width D3 of the lower end surface of the tool body 1 is basically 60 mm. In an example, the ratio of the width D3 of the lower end surface of the tool body 1 to the maximum width D1 of the projection of the tool body 1 on the horizontal plane is less than or equal to 0.8. The ratio of the width D4 of the battery mounting portion 6 to the maximum width D1 of the projection of the tool body 1 on the horizontal plane is less than or equal to 0.8. The width of the battery mounting portion 6 is less than the maximum width of the projection of the tool body 1 on the horizontal plane so that the width dimension of the tool body 1 does not increase. The ratio of the width D4 of the battery mounting portion 6 to the width D2 of the projection of the battery pack 3 on the horizontal plane is less than or equal to 0.5.

The maximum width D1 of the projection of the tool body 1 on the horizontal plane is less than or equal to the width D2 of the projection of the battery pack 3 on the horizontal plane. The width of the battery pack 3 is the maximum width of the chainsaw. In the case where the balance of the whole machine is ensured and the tool body 1 does not tilt, the width of the tool body 1 does not increase, thereby not increasing the width of the chainsaw.

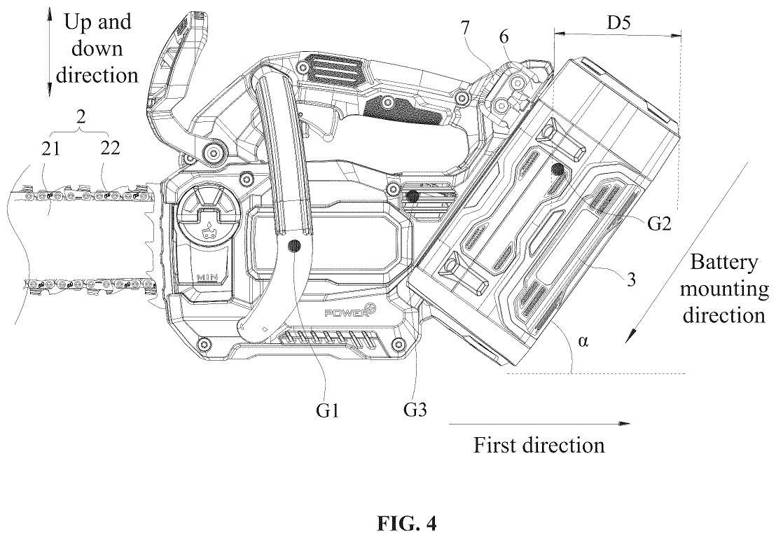

As shown in FIG. 4, an included angle α between the direction along which the battery pack 3 is mounted onto the tool body 1 and the first direction is greater than or equal to 50° and less than or equal to 60°. After the battery pack 3 is mounted onto the tool body 1, under the premise that the height of the battery pack 3 does not exceed the height of the tool body 1, the overall length of the chainsaw does not increase too much, thereby preventing the dimension of the chainsaw from being too large. The included angle α may be 50°, 51°, 52°, 53°, 54°, 55°, 56°, 57°, 58°, 59°, 60°, or the like, which is not specifically limited here.

After the battery pack 3 is mounted onto the tool body 1, the length increment D5 of the tool body 1 in the first direction is greater than or equal to 60 mm and less than or equal to 90 mm so that the overall length of the chainsaw does not increase too much, and the dimension of the chainsaw can be prevented from being too large, thereby ensuring the balance performance of the chainsaw. In the case where the lower end surface of the tool body 1 is disposed on the horizontal plane, the maximum height of the tool body 1 in the up and down direction is greater than or equal to the height of the battery pack 3. After the battery pack 3 is mounted, the overall height of the chainsaw does not increase.

With continued reference to FIG. 4, the tool body 1 on which the battery pack is not mounted has a first center of gravity G1, and the battery pack 3 has a second center of gravity G2. In the case where the lower end surface of the tool body 1 is disposed on the horizontal plane, the first center of gravity G1 is located below the second center of gravity G2, thereby avoiding the problem of the chainsaw tilting in the case where the chainsaw is at the balance position.

After the battery pack 3 is mounted on the tool body 1, the tool body 1 has a third center of gravity G3, and the third center of gravity G3 is located above the first center of gravity G1, thereby not causing the chainsaw to tilt. In addition, the first center of gravity G1 is located below the second center of gravity G2 so that it can be ensured that the third center of gravity G3 formed after the battery pack 3 is mounted on the tool body 1 is above the first center of gravity G1. In the second direction, the third center of gravity G3 is disposed between the first center of gravity G1 and the second center of gravity G2, thereby ensuring that the chainsaw does not tilt.

The first center of gravity G1 may be the center of gravity formed when the actuator 2 is mounted on the tool body 1 or may be the center of gravity formed when the actuator 2 is not mounted on the tool body 1.

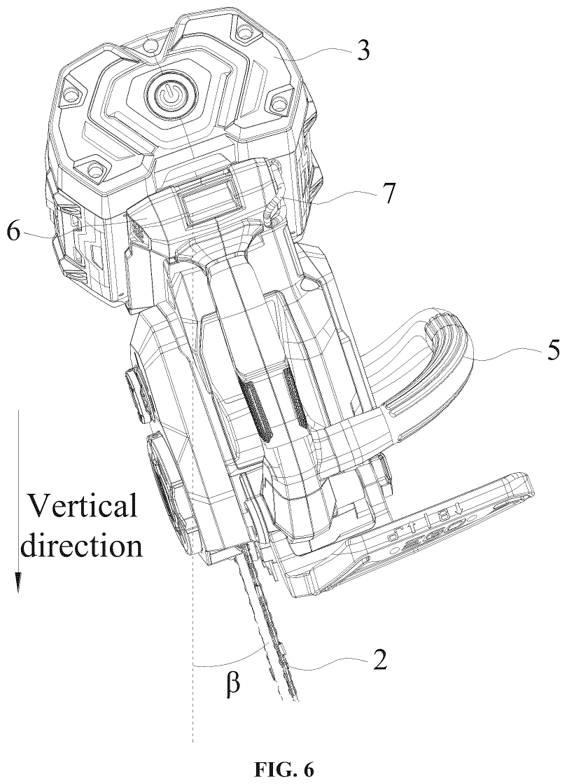

As shown in FIGS. 4, 5, and 6, the battery pack 3 is mounted at the rear end of the tool body 1. The battery mounting portion 6 is formed at the rear end of the tool body 1, and the battery pack 3 is mounted on the battery mounting portion 6. Further, a suspension part 7 is provided at the rear end of the tool body 1. In the case where the lower end surface of the tool body 1 is disposed on the horizontal plane, the suspension part 7 is located above the center of gravity of the tool body 1. The center of gravity of the tool body 1 may be the first center of gravity G1 when the battery pack 3 is not mounted or may be the third center of gravity G3 when the battery pack 3 is mounted. To meet safety regulations, the suspension part 7 is provided on the chainsaw, the battery pack 3 is mounted at the rear end of the tool body 1, the suspension part 7 is provided at the rear end of the tool body 1, and the suspension part 7 is provided without increasing the thickness of the housing of the tool body 1 or using a battery compartment. When the chainsaw is suspended via the suspension part 7, it is ensured that the included angle between the actuator 2 and the vertical direction is a safe included angle, and the actuator 2 does not rub against the human body, thereby improving the usage safety of the chainsaw.

The suspension part 7 is disposed on the side surface of the tool body 1 where the second handle 5 is formed, that is, the suspension part 7 and the second handle 5 are disposed on the same side, thereby not increasing the width of the tool body 1.

The suspension part 7 is disposed at the rear end of the first handle 4 and close to the upper end of the battery mounting portion 6. The suspension part 7 is provided without increasing the thickness of the housing of the tool body 1 or using a battery compartment.

The tool body 1 on which the battery pack 3 is not mounted has the first center of gravity G1. In the case where the lower end surface of the tool body 1 is disposed on the horizontal plane, the suspension part 7 is located above the first center of gravity G1. When the chainsaw is suspended via the suspension part 7, it is ensured that the included angle between the actuator 2 and the vertical direction is a safe included angle, and the actuator 2 does not rub against the human body, thereby improving the usage safety of the chainsaw.

The tool body 1 on which the battery pack 3 is mounted has the third center of gravity G3. In the case where the lower end surface of the tool body 1 is disposed on the horizontal plane, the suspension part 7 is located above the third center of gravity G3. When the chainsaw is suspended via the suspension part 7, it is ensured that the included angle between the actuator 2 and the vertical direction is a safe included angle, and the actuator 2 does not rub against the human body, thereby improving the usage safety of the chainsaw.

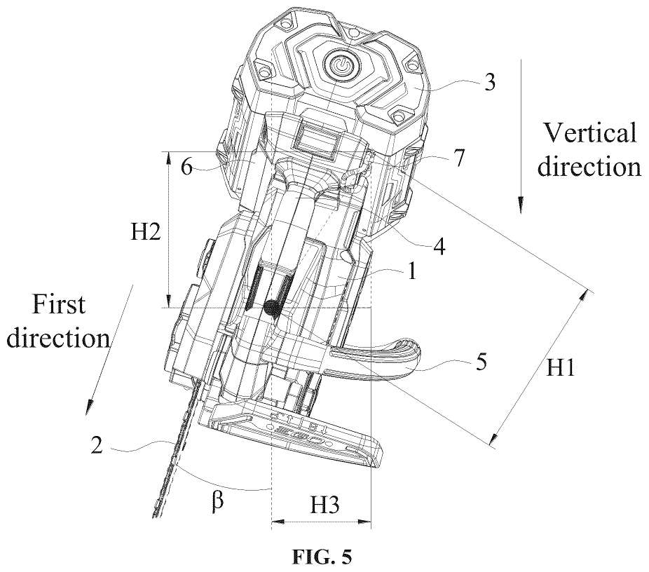

As shown in FIG. 5, the minimum distance H1 between the suspension part 7 and the first center of gravity G1 is greater than or equal to 55 mm.

In the case where the chainsaw is operated to be suspended by the suspension part 7, the minimum distance H2 between the suspension part 7 and the center of gravity of the tool body 1 in the vertical direction is greater than or equal to 45 mm, thereby ensuring that the included angle between the actuator 2 and the vertical direction is a safe included angle.

In the horizontal direction perpendicular to the vertical direction, the minimum distance H3 between the suspension part 7 and the first center of gravity G1 of the tool body 1 is greater than or equal to 30 mm, thereby ensuring that the included angle between the actuator 2 and the vertical direction is a safe included angle.

In the case where the chainsaw is operated to be suspended by the suspension part 7, an included angle β between the first direction and the vertical direction is greater than or equal to 15° and less than or equal to 22°. The first direction is the direction in which the actuator 2 extends, that is to say, the included angle β between the actuator 2 and the vertical direction is greater than or equal to 15° and less than or equal to 22° so that it is ensured that the included angle between the actuator 2 and the vertical direction is a safe included angle, thereby preventing the actuator 2 from rubbing against the human body.

In this example, the rated voltage of the battery pack 3 is greater than or equal to 4 V. For example, the rated voltage of the battery pack 3 may be 8 V, 12 V, 24 V, or the like.

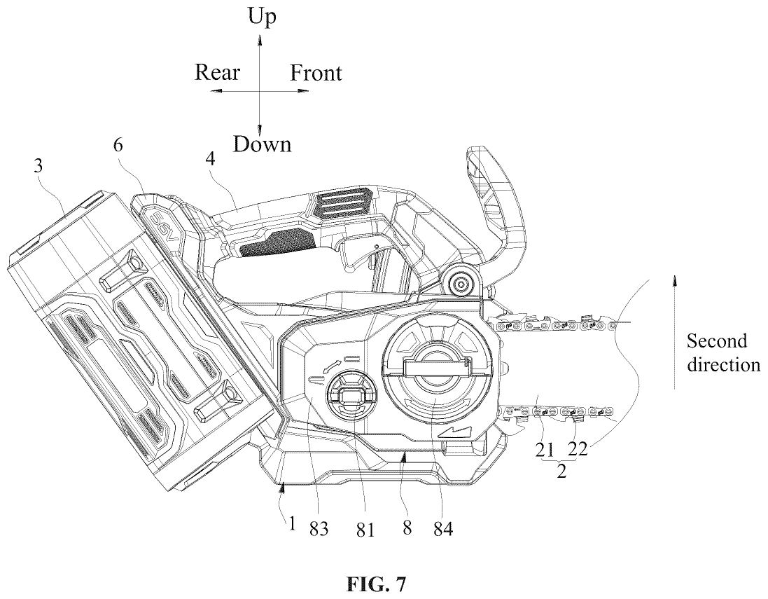

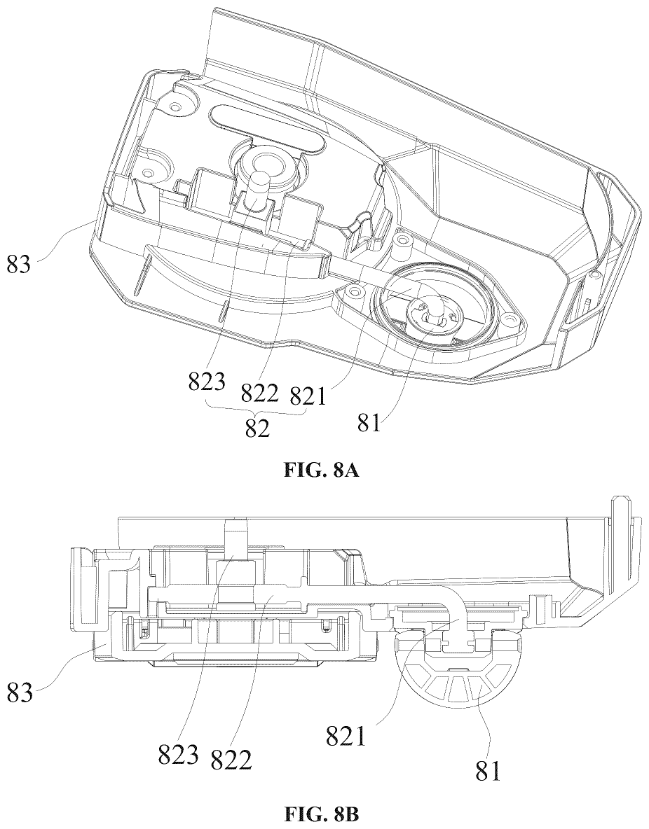

As shown in FIGS. 7, 8A, and 8B, the actuator 2 of the chainsaw includes the chain guide plate 21 on which the chain 22 is supported. The chainsaw further includes a tensioning system 8 mounted on the tool body 1. The tensioning system 8 is operated to adjust the tension of the chain 22 to ensure the working effect of the chainsaw.

The tensioning system 8 includes an adjustment knob 81 and a tensioning device 82. The adjustment knob 81 is operated to adjust the tension, which is easy to operate without the need for tools. The tensioning device 82 is connected to the chain guide plate 21 and is configured to adjust the tension in response to the rotational state of the adjustment knob 81.

The tensioning system 8 further includes a chain cover 83. The chain cover 83 is mounted on the tool body 1. The adjustment knob 81 is disposed on the chain cover 83. The tensioning device 82 is mounted on the inner side of the chain cover 83. The tensioning device 82 and the adjustment knob 81 are integrated on the chain cover 83 so that the chain cover 83 and the tensioning system 8 can be disassembled at the same time and mounted at the same time.

The adjustment knob 81 and the tensioning device 82 are flexibly connected so that the weight and dimension of the tensioning device 82 can be reduced, thereby reducing the dimension of the chain cover 83 and reducing the production cost.

The rotary force generated by operating the adjustment knob 81 to rotate is transmitted to the tensioning device 82 along the direction of a curve, thereby changing the force transmission direction, achieving the tensioning of the chain 22, simplifying the structure, and reducing the production cost.

The tensioning device 82 includes a flexible shaft 821. The rotary force of the adjustment knob 81 is transmitted to the chain guide plate 21 through the flexible shaft 821, and the direction of the force is changed through the tensioning device 82, thereby achieving the tensioning of the chain 22, reducing the weight and dimension of the tensioning device 82, reducing the dimension of the chain cover 83, and reducing the production cost.

In an example, the tensioning device 82 connected to at least the adjustment knob 81 is configured to be the flexible shaft 821, and the flexible shaft 821 is used for changing the force transmission direction, thereby implementing the tensioning function.

The tensioning device 82 includes a tensioning shaft 822 and a tensioning pin 823. The tensioning pin 823 rotates with the rotation of the adjustment knob 81. An end of the tensioning pin 823 is threadedly connected to the tensioning shaft 822, and the other end of the tensioning pin 823 is connected to the chain guide plate 21. At least part of the tensioning shaft 822 is configured to be the flexible shaft 821. The tensioning shaft 822 is rotatably disposed on the chain cover 83. The rotary force of the adjustment knob 81 is transmitted to the tensioning shaft 822 through the flexible shaft 821, the tensioning shaft 822 rotates, and the tensioning pin 823 moves along the axial direction of the tensioning shaft 822 to achieve the tensioning of the chain 22. Compared with the existing structure, the weight and dimension of the tensioning device 82 are reduced, thereby reducing the dimension of the chain cover 83 and reducing the production cost.

The ratio of the length of the flexible shaft 821 to the length of the tensioning shaft 822 is less than or equal to 1, that is, the length of the flexible shaft 821 is less than or equal to the length of the tensioning shaft 822, thereby ensuring that the tensioning range of the chain 22 is within a required range.

The length of the flexible shaft 821 is at least about 25 mm, for example, at least any value between 20 mm and 30 mm.

The tensioning shaft 822 further includes a leadscrew, and the tensioning pin 823 is connected to the leadscrew, thereby achieving a threaded connection between the tensioning pin 823 and the tensioning shaft 822. The structure is simple and easy to implement.

The flexible shaft 821 is press-fitted to the leadscrew. The connection process is simple and the connection stability is good. The connection manner between the flexible shaft 821 and the adjustment knob 81 includes one of a press-fit connection, an injection molding connection, and a die-casting connection.

In a direction perpendicular to a plane where the chain guide plate 21 is located, the maximum thickness of the chain cover 83 is less than or equal to 40 mm. For example, the maximum thickness may be 35 mm, 38 mm, 40 mm, or the like. Since the tensioning device 82 includes the flexible shaft 821, the dimension of the tensioning device 82 is reduced so that the thickness of the chain cover 83 does not increase in the case where the tensioning device 82 and the adjustment knob 81 are mounted on the chain cover 83.

The weight of the chain cover 83 is basically 150 g, for example, 145 g, 150 g, or 155 g. The flexible shaft 821 is provided so that the weight of the tensioning device 82 is reduced. In the case where the tensioning device 82 and the adjustment knob 81 are mounted on the chain cover 83, the weight of the chain cover 83 does not need to be increased.

The adjustment knob 81 is a flip cover structure so that after the adjustment knob 81 is mounted onto the chain cover 83, the dimension of the chain cover 83 in the direction perpendicular to the plane where the chain guide plate 21 is located can be reduced.

Further, a compression knob 84 is provided on the chain cover 83. The compression knob 84 has the same rotation direction as the adjustment knob 81 to match the customer's instinctive reaction. The compression knob 84 and the adjustment knob 81 rotate in the same direction to achieve tightening or loosening.

The distance between the center of rotation of the compression knob 84 and the center of rotation of the adjustment knob 81 in the first direction is 50 mm to 65 mm, thereby limiting the dimension of the chain cover 83 and the dimension of the chainsaw in the first direction without affecting the tensioning stroke of the chain 22.

The distance between the center of rotation of the compression knob 84 and the center of the adjustment knob 81 in the second direction is 12 mm to 24 mm, thereby not affecting the discharge of sawdust entering the chain cover 83.

The compression knob 84 is also a flip cover structure so that after the compression knob 84 is mounted onto the chain cover 83, the dimension of the chain cover 83 in the direction perpendicular to the plane where the chain guide plate 21 is located can be reduced.

In an example, the chainsaw further includes a first tensioning system and a second tensioning system. The first tensioning system is detachably mounted on the tool body 1, and the first tensioning system is operated to adjust the tension of the chain with the aid of an external tool. The second tensioning system is detachably mounted on the tool body 1 and is operated to adjust the tension of the chain 22. The second tensioning system includes the adjustment knob 81 and the tensioning device 82. The adjustment knob 81 is operable to adjust the tension. The tensioning device 82 is connected to the chain guide plate 21 and is configured to adjust the tension in response to the rotational state of the adjustment knob 81. The tensioning device 82 includes the flexible shaft 821. The chainsaw is equipped with two different types of tensioning systems. The user may mount different tensioning systems on the tool body 1 according to requirements so that the chainsaw has strong flexibility in use. In addition, the second tensioning system adjusts the tension through the tensioning device 82 by rotating the adjustment knob 81, which is easy to operate without the need for tools. The tensioning device 82 includes the flexible shaft 821. Compared with the existing structure, the weight and dimension of the tensioning device 82 are reduced, thereby reducing the dimension of the chain cover 83 and reducing the production cost.

The other structures of the second tensioning system may be the same as those of the preceding tensioning system. The details are not repeated here.

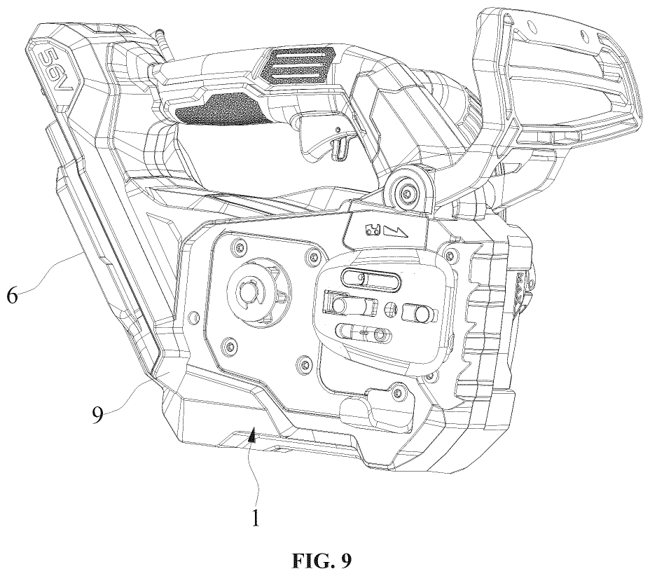

As shown in FIGS. 7 and 9, the chainsaw includes the tool body 1, the battery mounting portion 6 is formed at the rear end of the tool body 1, and the battery pack 3 is mounted on the battery mounting portion 6. The chain cover 83 is provided on the left side or right side of the tool body 1. When the actuator 2 performs cutting, sawdust enters the chain cover 83. A sawdust discharge channel is provided on the inner side of the chain cover 83. A sawdust discharge opening is provided between the chain cover 83 and the tool body 1. Sawdust is discharged from the chain cover 83 through the sawdust discharge opening under the guidance of the sawdust discharge channel. However, during the discharge process, a problem that sawdust is sprayed onto the battery pack 3 exists. To solve this problem, in the existing art, the chain cover 83 is used for guiding and shielding sawdust to prevent sawdust from being sprayed directly onto the battery pack 3. However, in this solution, the dimension of the chain cover 83 in the up and down direction increases, thereby increasing the dimension of the chainsaw. Therefore, in the present application, a sawdust guard rib 9 is provided on the tool body or the battery mounting portion 6 and disposed between the sawdust discharge opening and the battery pack 3. The sawdust guard rib 9 can guide the discharged sawdust, thereby preventing sawdust from being sprayed directly onto the battery pack 3. Moreover, the dimension of the chain cover 83 in the up and down direction is reduced.

The sawdust guard rib 9 is integrally formed with the tool body 1 or the battery mounting portion 6, is detachably disposed on the tool body 1 or the battery mounting portion 6, or is formed by extending downward from the outer edge of the battery mounting portion 6. The sawdust guard rib 9 can shield at least the region below the center of the bottom surface of the battery pack 3.

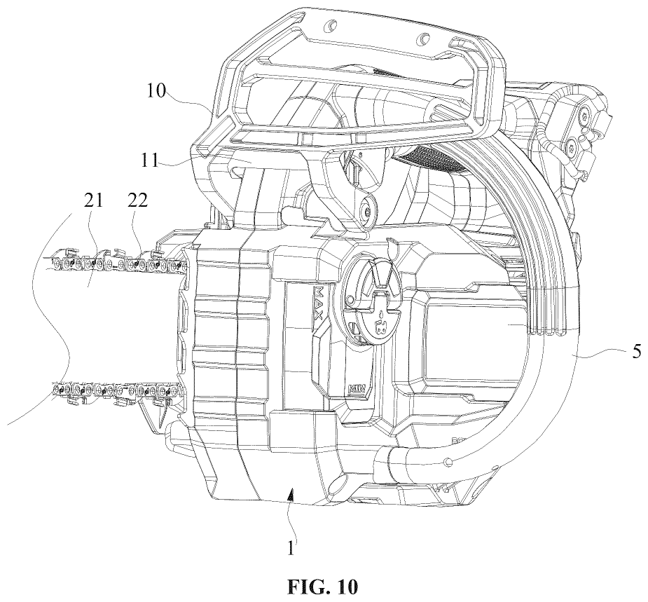

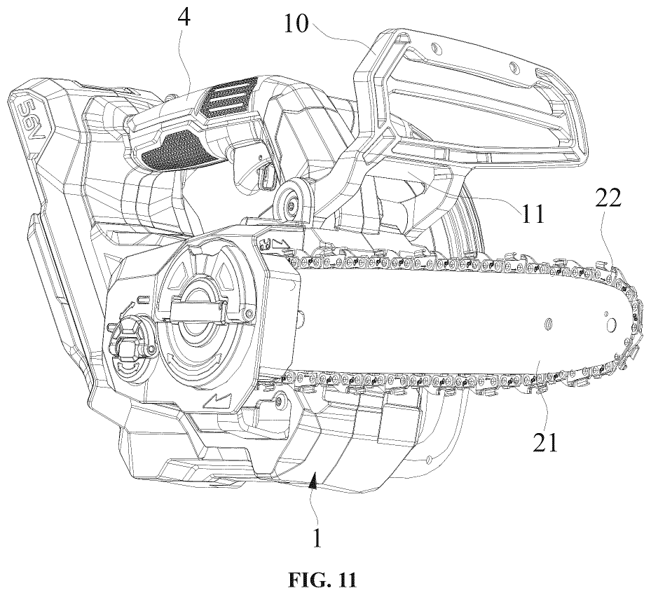

As shown in FIGS. 10 and 11, the chainsaw further includes a brake baffle 10, a gap exists between the brake baffle 10 and the tool body 1, a shielding rib 11 is provided on the brake baffle 10, and the shielding rib 11 is disposed at the gap to prevent the user's fingers from passing through the gap and touching the end of the chain 22 exposed to the outside. When the user uses the chainsaw, the user holds the first handle 4 with the right hand and the second handle 5 with the left hand. Due to the provision of the shielding rib 11, the fingers of the user's left hand cannot pass through the gap. The shielding rib 11 is disposed at the gap between the brake baffle 10 and the tool body 1 so that the length of the chainsaw can be shortened. In this manner, the existing art in which the distance between the brake baffle 10 and the end of the chain 22 exposed to the outside is increased to avoid the problem of the user's fingers passing through the gap and touching the end of the chain 22 exposed to the outside is replaced.

The shielding rib 11 is integrally formed with the brake baffle 10 or is non-detachably coupled to the brake baffle 10.

The shielding rib 11 is spaced apart from the tool body 1, and the gap between the shielding rib 11 and the tool body 1 is less than or equal to 20 mm to prevent human fingers from passing through the gap.

The shortest curve distance from the connection between the second handle 5 and the tool body 1 to the end of the chain 22 exposed to the outside is less than 120 mm, thereby shortening the length of the chainsaw compared with the existing art.

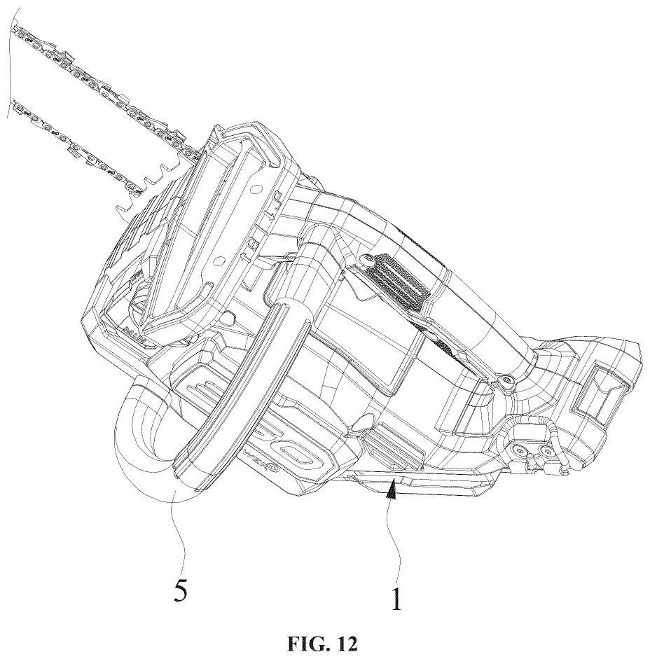

The chainsaw needs to be placed on its side when the chain guide plate 21 is replaced, so the chainsaw needs to have good stability when placed on its side. In the case where the battery pack 3 is mounted, the battery pack 3 and the second handle 5 form a stable support structure and can be supported on a plane so that the chainsaw can be placed on its side with the installation side of the chain guide plate 21 facing the user, making it easy for the user to replace the chain guide plate 21. As shown in FIG. 12, in the case where the battery pack 3 is not mounted, the tool body 1 and the second handle 5 form a stable support structure and can be supported on a plane so that the chainsaw can be placed on its side with the installation side of the chain guide plate 21 facing the user, making it easy for the user to replace the chain guide plate 21.

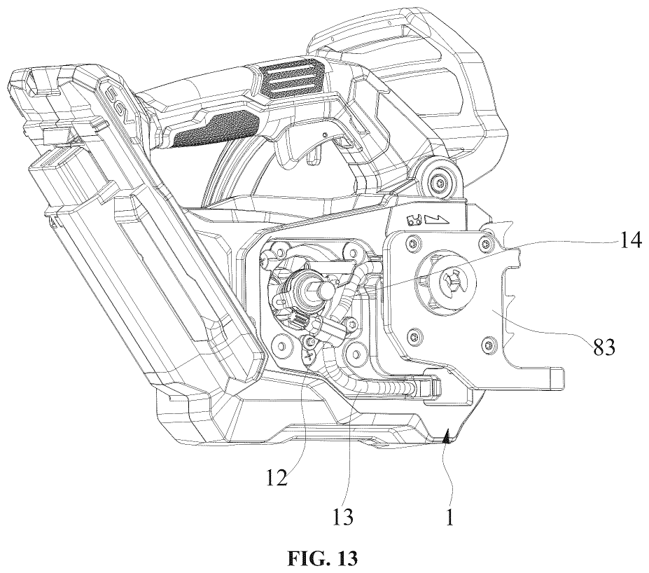

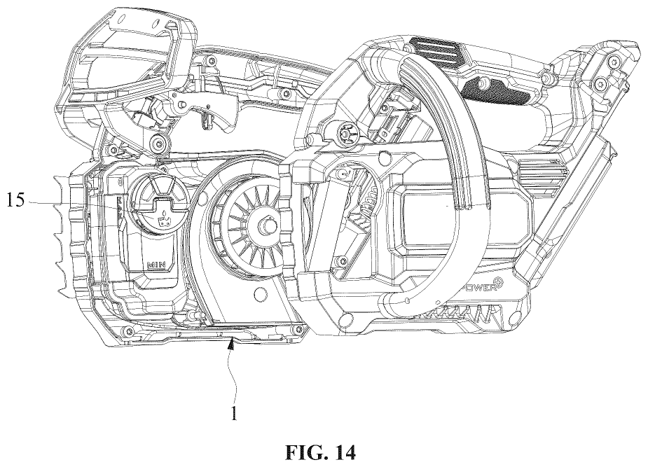

As shown in FIGS. 13 and 14, the chainsaw further includes an oil pump 12 and an oil tank 15. The oil pump 12 is a wear-and-tear part that requires regular cleaning and maintenance. The oil pump 12 and the oil tank 15 are disposed on two opposite sides of the chainsaw. The oil pump 12 is disposed in a cavity covered by the chain cover 83. The oil pump 12 can be exposed by opening the chain cover 83, thereby facilitating cleaning and maintenance. Furthermore, the oil pump 12 is positioned in a way suitable for a chainsaw with an electronic brake, thereby reducing costs.

An oil inlet pipe 13 is detachably provided at the input end of the oil pump 12, and an oil outlet pipe 14 is detachably connected to the output end of the oil pump 12 so that the oil pump 12 can be quickly cleaned and replaced.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

### REFERENCE LIST

1 tool body
2 actuator
21 chain guide plate
22 chain
3 battery pack
4 first handle
5 second handle
6 battery mounting portion
7 suspension part
8 tensioning system
81 adjustment knob
82 tensioning device
821 flexible shaft
822 tensioning shaft
823 tensioning pin
83 chain cover
84 compression knob
9 sawdust guard rib
10 brake baffle
11 shielding rib
12 oil pump
13 oil inlet pipe
14 oil outlet pipe
15 oil tank
16 power supply mounting portion
17 power conversion device
18 portable power supply
181 first battery pack
182 backpack assembly
183 power cord

What is claimed is:

1. A handheld power tool, comprising:
a tool body;
a battery mounting portion disposed on the tool body and used for mounting a battery pack;
an electric motor disposed in the tool body; and
a control circuit, configured to control a startup or a rotational state of the electric motor, comprising a parameter detection module for acquiring battery communication data at least when the battery pack is mounted onto the battery mounting portion and a controller for determining, according to the battery communication data, a center of gravity of the tool body on which the battery pack is mounted and for not starting the electric motor when a change in the center of gravity relative to a preset center of gravity is greater than a change threshold.

2. The handheld power tool of claim 1, wherein the controller is configured to acquire the change by looking up a table chart according to the battery communication data.

3. The handheld power tool of claim 1, wherein the controller is configured to issue alarm information when the change is greater than the change threshold.

4. The handheld power tool of claim 1, wherein the controller is configured to disconnect a power supply path between the battery pack and the electric motor when the change is greater than the change threshold.

5. The handheld power tool of claim 1, wherein the controller is configured to send a no-start control signal when the change is greater than the change threshold so that the electric motor does not start.

6. The handheld power tool of claim 1, wherein the controller is configured to not respond to a start signal when the change is greater than the change threshold so that the electric motor does not start.

7. The handheld power tool of claim 1, wherein the battery communication data comprises at least one of a battery pack model, a battery pack weight, a battery pack capacity, and a battery pack volume.

8. A handheld power tool, comprising:
a tool body;
a battery mounting portion disposed at a rear end of the tool body and used for mounting a battery pack;
an electric motor disposed in the tool body; and
a control circuit, configured to control startup or a rotational state of the electric motor, comprising a parameter detection module for acquiring battery communication data at least when the battery pack is mounted onto the battery mounting portion and a controller for identifying the battery pack according to the battery communication data and for not starting the electric motor when a type of the battery pack does not satisfy a startup requirement.

9. The handheld power tool of claim 8, wherein the controller is configured to acquire the type of the battery pack by looking up a table chart according to the battery communication data.

10. The handheld power tool of claim 8, wherein the controller is configured to issue alarm information when the type of the battery pack does not satisfy the startup requirement.

11. The handheld power tool of claim 8, wherein the controller is configured to disconnect a power supply path between the battery pack and the electric motor when the type of the battery pack does not satisfy the startup requirement so that the electric motor does not start.

12. The handheld power tool of claim 8, wherein the controller is configured to send a no-start control signal when the type of the battery pack does not satisfy the startup requirement so that the electric motor does not start.

13. The handheld power tool of claim 8, wherein the controller is configured to not respond to a start signal when the type of the battery pack does not satisfy the startup requirement so that the electric motor does not start.

14. A chainsaw, comprising:
a tool body;
a battery mounting portion disposed on the tool body and used for mounting a battery pack;
an electric motor disposed in the tool body; and
a control circuit, configured to control startup or a rotational state of the electric motor, comprising a parameter detection module for acquiring battery communication data at least when the battery pack is mounted onto the battery mounting portion and a controller for determining, according to the battery communication data, a center of gravity offset of the tool body on which the battery pack is mounted, and for not starting the electric motor when the center of gravity offset is greater than an offset threshold.

15. The chainsaw of claim 14, wherein the controller is configured to acquire the center of gravity offset by looking up a table chart according to the battery communication data.

16. The chainsaw of claim 14, wherein the controller is configured to issue alarm information when the center of gravity offset is greater than the offset threshold.

17. The chainsaw claim 14, wherein the controller is configured to disconnect a power supply path between the battery pack and the electric motor when the center of gravity offset is greater than the offset threshold so that the electric motor does not start.

18. The chainsaw of claim 14, wherein the controller is configured to send a no-start control signal when the center of gravity offset is greater than the offset threshold so that the electric motor does not start.

19. The chainsaw of claim 14, wherein the controller is configured to not respond to a start signal when the center of gravity offset is greater than the offset threshold so that the electric motor does not start.

20. The chainsaw of claim 14, wherein the battery communication data comprises at least one of a battery pack model, a battery pack weight, a battery pack capacity, and a battery pack volume.
